(19) United States
(12) Patent Application Publication
(10) Pub. No.: US 2006/0038559 A1
(43) Pub. Date: Feb. 23, 2006

(54) Magnetically biased eddy current sensor

(75) Inventors: Wayne A. Lamb, Freeport, IL (US); Curtis B. Johnson, Franklin, WI (US)

Correspondence Address: Kris T. Fredrick;Honeywell International, Inc., 101 Columbia Rd., P.O. Box 2245, Morristown, NJ, 07962, US

(73) Assignee: Honeywell International, Inc.

(21) Appl. No.: 11/045,667

(22) Filed: Jan. 28, 2005

Related U.S. Application Data
(60) Provisional application No. 60/603,329, filed on Aug. 20, 2004.

(51) Int. Cl. G01N 27/82

(52) U.S. Cl. 324/242

(57) ABSTRACT

Eddy currents arise when a conductive material moves through a magnetic field. Eddy currents, like all electric currents, generate a magnetic field. The generated magnetic field can be detected and measured through use of one or more magnetically biased GMR elements. In general, an eddy current sensor can be configured, which includes a magnet, and a first giant magnetoresistive element placed such that the magnetic field from the magnet biases the giant magnetoresistive element along its primary axis.

### TECHNICAL FIELD

Embodiments relate to the field of magnetic sensing. Embodiments also relate to the use of giant magnetoresistive sensing to detect the eddy currents in a conductor passing through a magnetic field.

### BACKGROUND OF THE INVENTION

Many applications require the ability to sense or detect the movement of an electrically conductive material. Sensing the rotation of a turbine with aluminum fins is one example. Aluminum is an electrically conductive material and the fins move as the turbine rotates. There are many ways to measure turbine rotation, but they usually require fixing a target to the rotating part. The target adds complexity and a possible failure point to the structure.

Magnets, such as the one shown in FIG. 1, labeled as prior art, are well known devices. A magnet 102 has a north pole 103, a south pole 104, and a magnetic field often indicated by magnetic field lines 101. Magnets have many interesting properties. One property is attracting pieces of iron. Another property is electrically conductive material moving through a magnetic field causes an electrical current to flow within the electrically conductive material. FIG. 2, labeled as prior art, illustrates eddy currents 202 being produced as an aluminum plate 201 is moved into the page past a stationary magnet 102. The eddy currents 202 create a magnetic field 203 because all electrical currents generate a magnetic field. If a sensor (not shown) detects the magnetic field 203, then it has also detected the eddy currents 202 and the movement of the aluminum plate 201. However, the sensor must be able to see the eddy current induced magnetic field 203 in the presence of the magnetic field produced by the magnet 102.

There are many types of sensors that can detect magnetic fields. A giant magnetoresistive (GMR) element is able to detect extremely weak magnetic fields. The use and construction of GMR elements is known by those skilled in the art of magnetic sensors. FIG. 3 illustrates a GMR element 300 in the rest state. The rest state means that there are no external magnetic fields affecting the GMR element. It is made of an upper layer of alloy 301, a conductive non-magnetic layer 303, and a lower layer of alloy 302. The alloy layers are produced such that they have magnetic moments. The upper magnetic moment 304 points in one direction and the lower magnetic moment 306 points in the exact opposite direction due to coupling between the layers.

In FIG. 3, labeled as prior art, the lower magnetic moment is depicted pointing in the same direction as the GMR element's secondary axis 308. The secondary axis 308 always points in the same direction as either the upper magnetic moment 304 points or the lower magnetic moment 306 points when the GMR element 300 is in the rest state. The primary axis 307 of the GMR element is orthogonal to the secondary axis and in the plane of the GMR element layers. The normal axis 309 is orthogonal to the other two axes. A GMR element in the rest state resists electrical current 305 moving along the primary axis in the conductive non-magnetic layer 303.

FIG. 4, labeled as prior art, illustrates a GMR element in the active state. The active state means that external magnetic fields are affecting the GMR element. The external magnetic field causes the upper magnetic moment 401 and the lower magnetic moment 402 to point along the primary axis 307. A GMR element in the active state resists electrical current 305 moving along the primary axis 307 less than it does when in the rest state. Notice that the electrical current experiences the same resistance when it travels along the primary axis or travels in the directly opposite direction.

FIG. 5, labeled as prior art, illustrates a serpentine GMR element 503. The serpentine GMR element has a primary axis 307 and secondary axis 308. The view of FIG. 5 is top down. The upper alloy layer is shown with the other layers directly underneath. Electrical current flows between the ends 501 of the serpentine pattern. Serpentine patterns are well known to those skilled in the art of electrical component design and are commonly used to increase the resistance to electrical current.

FIG. 6, labeled as prior art, illustrates a Wheatstone bridge 600. Wheatstone bridges are well known to those skilled in the art of electrical circuits and are used for the precise measurement of or detection of changes in electrical resistance. A source voltage is applied between the positive input terminal 601 and the negative input terminal 602. On the left side, current flows from the positive input terminal 601, through R1 603, which is the first resistive element, through the negative output terminal 607, through R2 604, which is the second resistive element, and finally out the negative input terminal 602.

On the right side, current flows from the positive input terminal 601, through R3 606, which is the third resistive element, through the positive output terminal 608, through R4 605, which is the fourth resistive element, and finally out the negative input terminal 602. If the magnetic field strength at each resistive element of a Wheatstone bridge 600 is different and the resistive elements are GMR elements then precise sensing and measurement of magnetic field differences can be accomplished.

The output voltage of a Wheatstone bridge 600 is the voltage at the positive output terminal 608 minus the voltage at the negative output terminal 607. Reducing either R1 603 or R4 605 causes the output voltage to drop. Reducing both R1 603 and R4 605 causes the output voltage to drop even more. Similarly, reducing R3 606, R2 604, or both causes an increase in the output voltage.

FIG. 7, labeled as prior art, illustrates a dual serpentine GMR element 705. Dual serpentine patterns are well known to those skilled in the art of electrical component design and are commonly used when two identical electrical paths are desired. An electrical current entering one end 701 and exiting the second end 702 will have traversed an almost identical path as an electrical current that enters the third end 703 and exits the fourth end 704. One factor of identical paths is that an external magnetic field will affect currents in either electrical path the same.

GMR elements were invented for the purpose of detecting magnetic fields. They have also been used as the resistive elements in a Wheatstone bridge. They have typically been used to detect very small magnetic fields, such as on a computer hard drive. However, magnetically biased GMR elements cannot be used in computer hard drives or similar applications because the magnetic field from the bias magnet will change the magnetic fields on the target. Furthermore, GMR elements have not been used to measure eddy currents where the eddy current is caused by the same magnetic field that biases the GMR element.

The present invention directly addresses the shortcomings of the prior art by magnetically biasing GMR elements to detect the magnetic fields created by eddy currents.

### BRIEF SUMMARY

It is therefore one aspect of the embodiments to detect the movement of conductive materials, such as aluminum turbine blades through the use of magnetically biased GMR elements.

It is another aspect of the embodiments to provide a single GMR element or a combination of GMR elements. A combination of GMR elements can be used as resistive elements of a Wheatstone bridge. The GMR elements can be laid out in a variety of formats including serpentine and dual serpentine.

It is further aspect of the embodiments to use biased GMR elements only for applications that can tolerate the magnetic bias field. Some applications, such as reading computer hard drives, require accurate sensing of small magnetic fields. However, using a magnet to bias a GMR element would also destroy the data on the hard drive. As such, biased GMR elements are most useful for applications that can tolerate the biasing magnetic field and that also require sensing small magnetic fields.

It is also another aspect of the embodiments that sensing the movement of magnetic materials is one of the applications well suited to the use of biased GMR elements. As discussed earlier, the movement causes eddy currents and the eddy currents create a magnetic field. This application is particularly ideal because it not only tolerates the biasing magnetic field, but also requires it. The biasing magnetic field performs the double duty of GMR element biasing and eddy current causation.

It is an additional aspect of the embodiments that applications such as sensing turbine movement or fan blade movement are ideal for the use of biased GMR elements.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background, brief summary and detailed description, serve to explain the principles of the present invention.

FIG. 1, labeled as “prior art”, illustrates a magnet;

FIG. 2, labeled as “prior art”, illustrates eddy currents in a conductive material moving through a magnetic field and the magnetic field generated by the eddy currents;

FIG. 3, labeled as “prior art”, illustrates a GMR element in the rest state;

FIG. 4, labeled as “prior art”, illustrates a GMR element in the active state;

FIG. 5, labeled as “prior art”, illustrates a serpentine structure;

FIG. 6, labeled as “prior art”, illustrates a Wheatstone bridge;

FIG. 7, labeled as “prior art”, illustrates a dual serpentine structure;

FIG. 8 is a graph illustrating GMR element response curves in accordance with a preferred embodiment;

FIG. 9 illustrates placement of a GMR element near a magnet to achieve primary axis bias in accordance with a preferred embodiment;

FIG. 10 also illustrates placement of a GMR element near a magnet to achieve primary axis bias in accordance with a preferred embodiment;

FIG. 11 illustrates placement of a GMR element near a magnet to achieve primary axis bias and secondary axis bias in accordance with a preferred embodiment;

FIG. 12 also illustrates placement of a GMR element near a magnet to achieve primary axis bias and secondary axis bias in accordance with a preferred embodiment;

FIG. 13 illustrates placement of serpentine GMR elements on a substrate in accordance with a preferred embodiment;

FIG. 14 illustrates placement of serpentine GMR elements on a substrate in accordance with a preferred embodiment;

FIG. 15 illustrates placement of dual serpentine GMR elements on a substrate in accordance with a preferred embodiment;

FIG. 16 illustrates placement of dual serpentine GMR elements on a substrate in accordance with a preferred embodiment;

FIG. 17 illustrates a Wheatstone bridge connected to sensing circuitry in accordance with a preferred embodiment; and

FIG. 18 illustrates an eddy current sensor in accordance with a preferred embodiment.

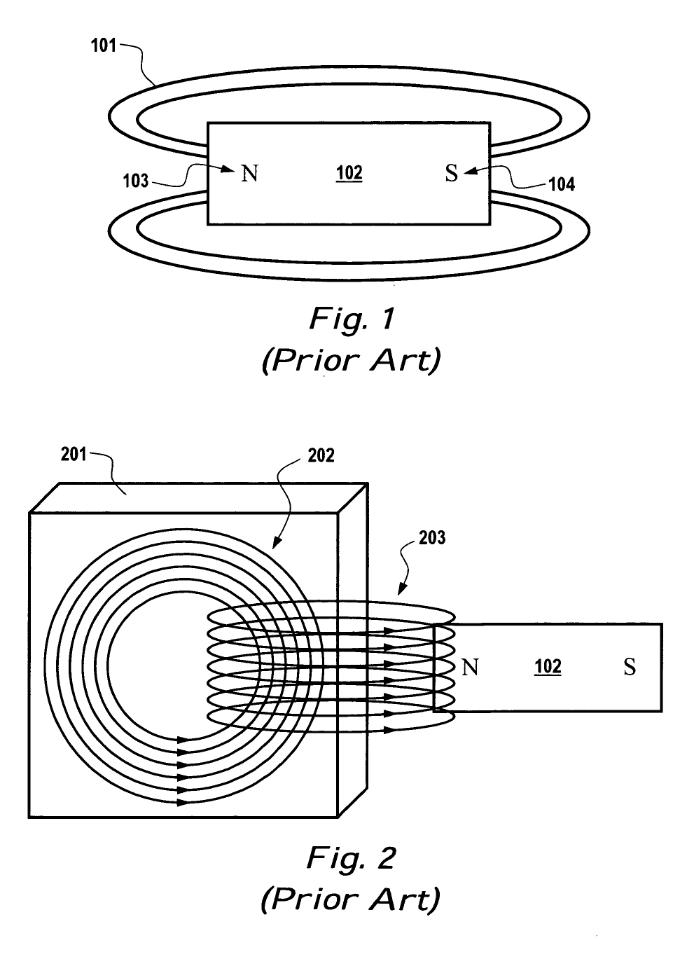

### DETAILED DESCRIPTION

Biasing is a technique commonly used in electronic circuitry, especially in electronic amplifiers. It can be applied to GMR elements with the realization that the bias must be applied magnetically whereas electronic circuits are biased electrically. The idea is to magnetically bias the GMR element to be in a favorable region of its response curve. A GMR element's response curve is its electrical resistance when subjected to different magnetic field strengths. When in the rest state, a GMR element exhibits a small resistance change for large magnetic field strength changes.

Similarly, in the active state, a GMR element again exhibits a small resistance change for large magnetic field strength changes. A biased GMR element is not in the rest state or the active state, but somewhere in between. The biased GMR element exhibits large resistance changes for small changes in magnetic field strength. Therefore, applications that require the detection of small magnetic fields are best met by using biased GMR elements.

Placing it near a magnet can bias a GMR element. However, the GMR element must be placed precisely because too far results in rest state and too close results in active state.

FIG. 8 illustrates a graph depicting GMR element response curves in accordance with aspects of the embodiment. The Y-axis 801 corresponds to increasing electrical resistance 803. The X-axis 802 corresponds to increasing magnetic field strength 804. The first curve 806 on the graph illustrates the reduction of electrical resistance as the magnetic field strengthens along the primary axis. When the magnetic field is weak, resistance is high. The dashed line 809 indicates a magnetic field strength near which the GMR element is in rest state. As the magnetic field strengthens, resistance increases briefly and then drops to a lower value. The dashed line 810 indicates a magnetic field strength at which the GMR element is in active state. When the GMR element is in either rest state or active state, changes in magnetic field strength cause little change to resistance. The dashed line 808 indicates a magnetic field strength that biases the GMR element along the primary axis. As can be seen, at the primary axis bias point 808, small changes in magnetic field strength result in large changes in resistance. The second curve 805 on the graph illustrates the reduction of electrical resistance as the magnetic field increases along the secondary axis. The second curve also exhibits magnetic field strengths corresponding to a rest state 809, active state 810 and bias point 807. There is no curve showing magnetic bias effects along the third axis because there are none.

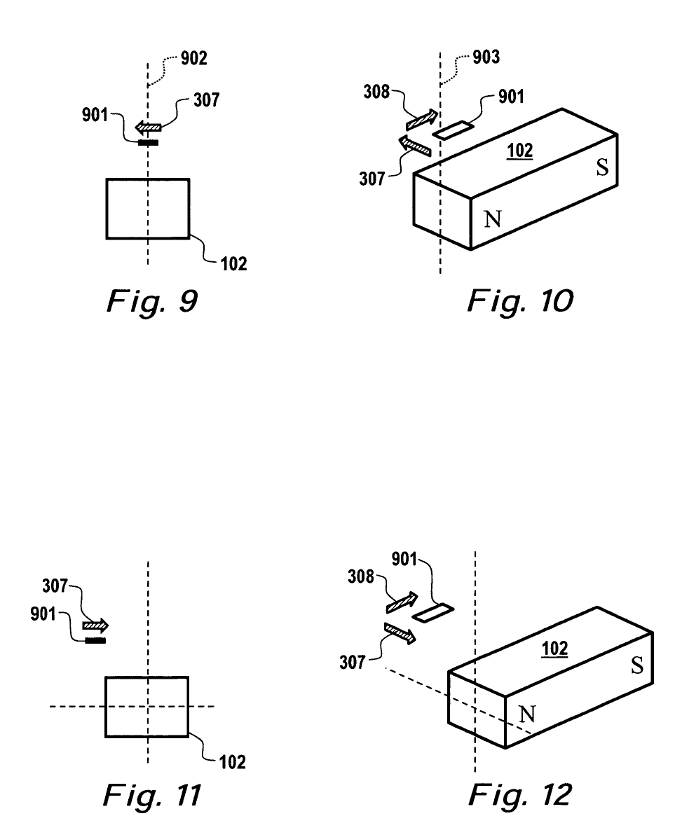

FIG. 9 illustrates placement of a GMR element 901 near a magnet 102 to achieve primary axis bias in accordance with an aspect of the embodiment. The GMR element 901 is placed above the magnet 102 and slightly forward of the face of the magnet 102. The forward placement cannot be observed in FIG. 9 because it is end on. The GMR element's secondary axis is not shown because it goes directly into the page. A dashed line is drawn straight up from the magnet 102. The GMR element's third axis is parallel to the dashed line. The GMR element's primary axis 901 is shown orthogonal to the other two axes. Placing the GMR element 901 as shown with respect to the magnet 102 results in a magnetic bias along the primary axis 307. The exact placement is application specific and can be determined empirically, analytically, or via simulation.

FIG. 10 also illustrates placement of a GMR element 901 near a magnet 102 to achieve primary axis bias in accordance with an aspect of the embodiment. FIG. 10 illustrates the same elements in the same positions as FIG. 9, but from a different view. Additionally, the GMR element's secondary axis 308 can now be seen.

FIG. 11 illustrates placement of a GMR element 901 near a magnet 102 to achieve primary axis bias and secondary axis bias in accordance with an aspect of the embodiment. The elements are the same as in FIG. 9 and FIG. 10 with the exception of shifting the GMR element 901 in the direction of the primary axis.

FIG. 12 also illustrates placement of a GMR element 901 near a magnet 102 to achieve primary axis bias and secondary axis bias in accordance with an aspect of the embodiment. FIG. 12 illustrates the same elements in the same positions as FIG. 11, but from a different view. Additionally, the GMR element's secondary axis 308 can now be seen.

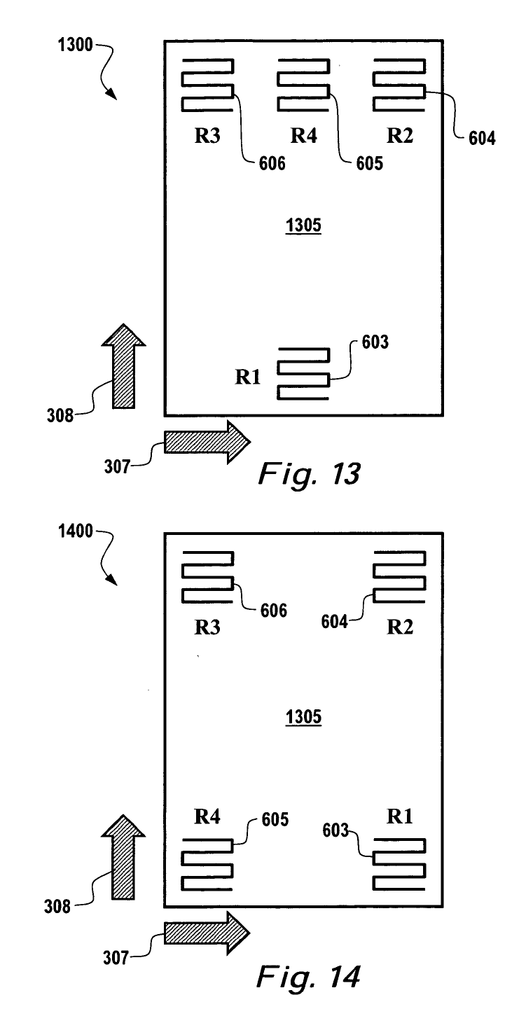

FIG. 13 illustrates placement of serpentine GMR elements on a substrate 1305 in accordance with another aspect of the embodiment. The four GMR elements are electrically connected as the resistive elements of a Wheatstone bridge. GMR element R1 603 lies on one side of the substrate 1305 while the other GMR elements lie on the other side. The substrate 1305 and elements on it can be placed in a magnetic field as if the entire assembly 1300 is a single GMR element.

The primary axis 307 and secondary axis 308 of the assembly 1300 are shown and can be seen to coincide with the primary and secondary axes of each of the four GMR elements. The GMR resistive elements are labeled 603, 604, 605, and 606 in direct correlation with the labeling of Wheatstone bridge resistive elements in FIG. 6. The reason for this placement of GMR elements is so that R1 603 can be placed closer to the moving conductive material. As such, the magnetic field at R1 603 will change more than at the other GMR elements and causes a change in the Wheatstone bridge output voltage.

FIG. 14 illustrates placement of serpentine GMR elements on a substrate 1305 in accordance with another aspect of the embodiment. Here, GMR element R1 603 and GMR element R2 605 are on one side of the substrate with GMR element R2 606 and GMR element R3 604 on the other. Otherwise, the labeling, electrical interconnection, and magnetic biasing of the assembly 1400 is the same as for assembly 1300 shown in FIG. 13. The reason for this physical arrangement of GMR elements is so that R1 603 and R4 605 can be placed closer to the moving conductive material. As such, the magnetic field at R1 603 and R4 605 will change more than at the other GMR elements and cause a larger change in the Wheatstone bridge output voltage than would be observed from assembly 1300 of FIG. 13.

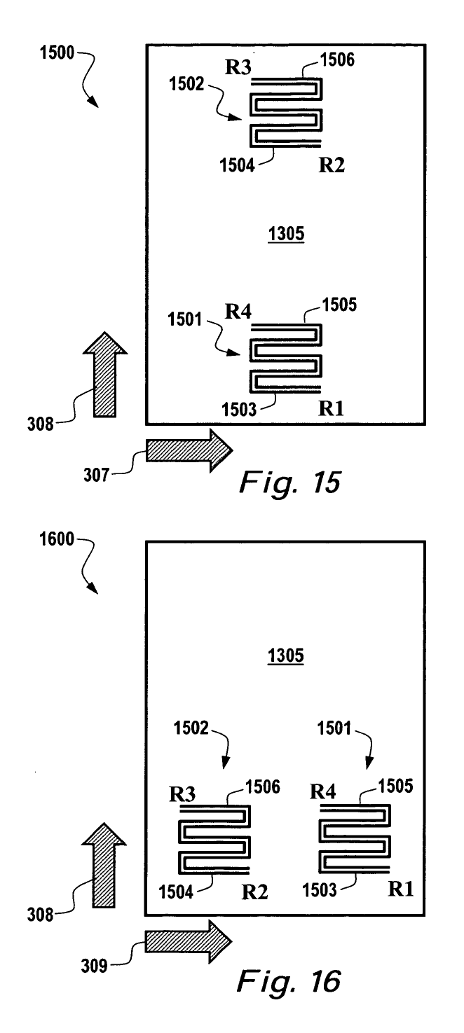

FIG. 15 illustrates placement of dual serpentine GMR elements on a substrate 1305 in accordance with another aspect of the embodiment. The first dual serpentine GMR element 1501 contains electrical paths corresponding to R1 1503 and R4 1505. The other dual serpentine GMR element 1502 contains electrical paths corresponding to R2 1504 and R3 1506. The four electrical paths are electrically connected to form a Wheatstone bridge. The electrical path R1 1503 corresponds to Wheatstone bridge element R1 603 in FIG. 6.

The electrical path R2 1504 corresponds to Wheatstone bridge element R2 604 in FIG. 6. The electrical path R3 1506 corresponds to Wheatstone bridge element R3 606 in FIG. 6. The electrical path R4 1505 corresponds to Wheatstone bridge element R4 605 in FIG. 6. The assembly 1500 of dual serpentine resistive elements on a substrate 1305 can be placed in a magnetic field as if the entire assembly 1500 is a single GMR element. The primary axis 307 and secondary axis 308 of the assembly 1500 are shown and can be seen to coincide with the primary and secondary axes of the dual serpentine GMR elements.

The reason for the FIG. 15 assembly's 1500 physical arrangement of GMR elements is so that R1 1503 and R4 1505 can be placed closer to moving conductive material. As such, the magnetic field at R1 1503 and R4 1505 will change more than for the other GMR elements and cause a change in the Wheatstone bridge output voltage.

FIG. 16 illustrates placement of dual serpentine GMR elements on a substrate 1305 in accordance with another aspect of the embodiment. The difference between the FIG. 16 assembly 1600 and the FIG. 15 assembly 1500 is the dual serpentine GMR elements are placed side by side but are still electrically connected to form a Whetstone bridge. The reason for this physical arrangement is that conductive material moving past the assembly in the direction of the primary axis 307 will be seen by the one dual serpentine GMR element 1502 and then the second 1501. The result is that the Wheatstone bridge output voltage will move strongly in one direction and then the other as the magnetic field generated by the eddy currents appears and disappears from each dual serpentine GMR element in turn.

Note that in describing FIGS. 13 through 16 elements were described as being on one side of the substrate or the other. The plane of the substrate is defined by the primary and secondary axes of the GMR elements and the assemblies. The “other side” is intended to mean the other side with respect to the direction of the secondary axis 308.

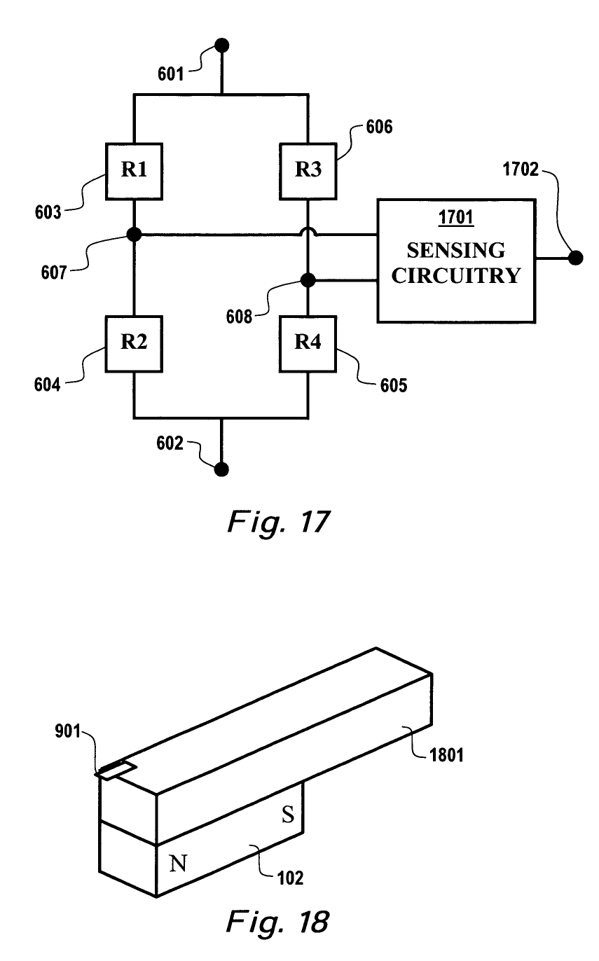

FIG. 17 illustrates a Wheatstone bridge connected to sensing circuitry 1701 in accordance another aspect of the embodiment. The Wheatstone bridge output voltage is input into the sensing circuit 1701 wherein it is processed to produce a sensor output 1702. The sensor output can be a voltage pulse each time an eddy current is sensed, a measurement of the magnetic field generated by the eddy current, or another value that is meritorious for a specific application.

FIG. 18 illustrates an eddy current sensor in accordance with another aspect of the embodiment. A GMR element 901 is placed near a magnet such that the GMR element 901 is biased by the magnetic field created by the magnet 102. Both the magnet 102 and the GMR element 901 are held by a structural element 1801. The purpose of the structural element 1801 is to cause the eddy sensor to become a unit that can be manufactured. Another purpose of the structural element 1801 is to preserve the spacing and alignment between the magnet 102 and GMR element 901.

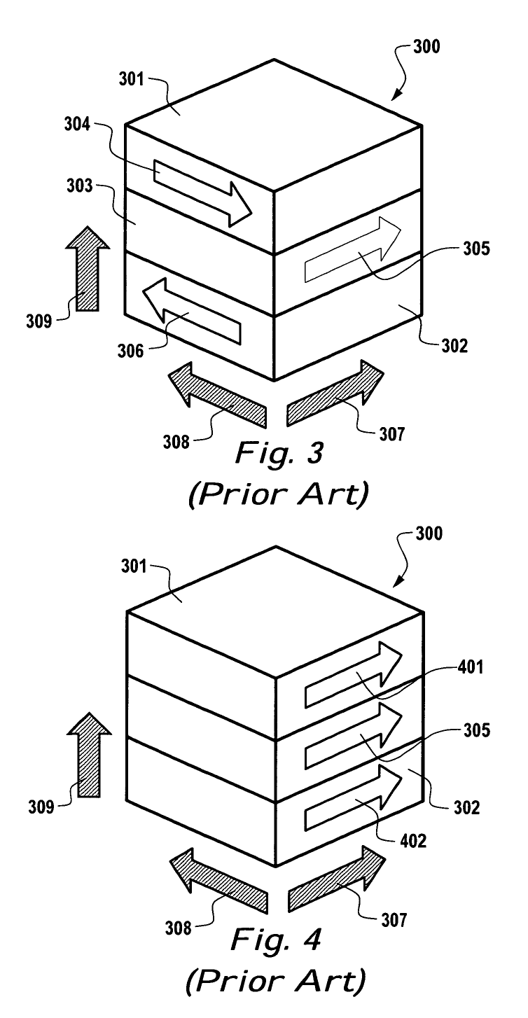

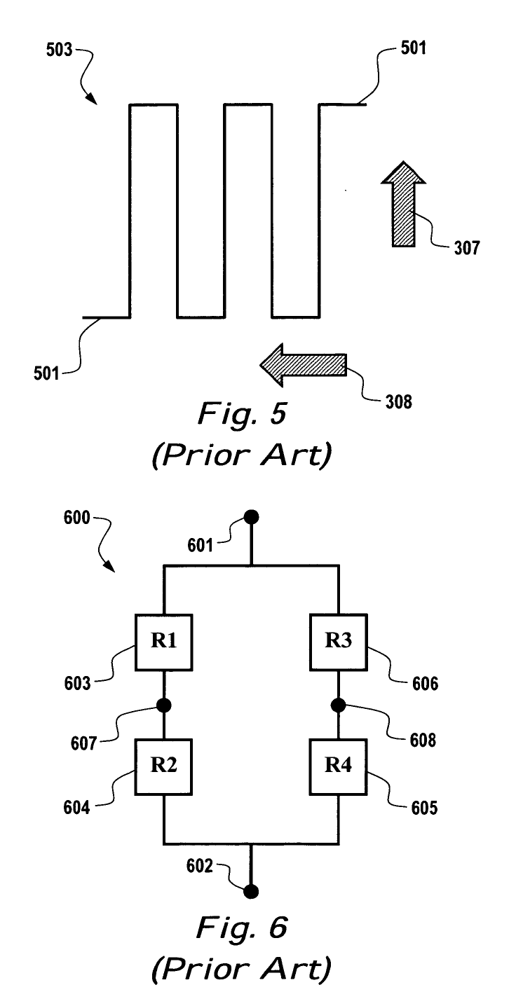

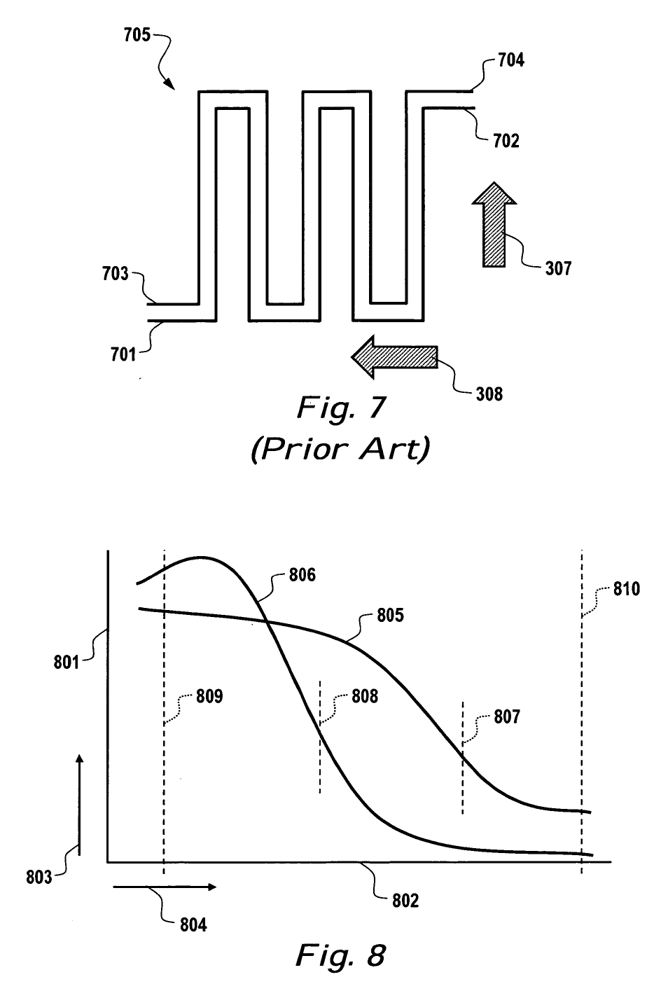

The GMR element 901 shown in FIGS. 9, 10, 11, 12, and 18 can use a single GMR element, such as that shown in FIG. 3. It can also have a serpentine or dual serpentine structure. Additionally, any of the assemblies shown in FIGS. 13 through 16 can be used in place of GMR element 901. The critical factor is that the primary and secondary axes of any element or assembly used in the position of GMR element 901 must be aligned in the magnetic field the same way as GMR element 901.

It will be appreciated that variations of the above-disclosed and other features, aspects and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An eddy current sensor comprising:
a magnet; and
a first giant magnetoresistive element placed such that the magnetic field from the magnet biases the giant magnetoresistive element along its primary axis.

2. The eddy current sensor of claim 1 further comprising three additional giant magnetoresistive elements magnetically biased along the primary axis and electrically connected with the first giant magnetoresistive element to form a Wheatstone bridge configuration.

3. The eddy current sensor of claim 2 wherein the magnetic field from the magnet also biases the giant magnetoresistive elements along their secondary axes.

4. The eddy current sensor of claim 3 further comprising sensing circuitry that reads the bridge voltage of the wheatstone bridge and produces an output that indicates the presence or absence of nearby eddy currents.

5. The eddy current sensor of claim 1 wherein the first giant magnetoresistive element is a dual serpentine giant magnetoresistive element and further comprising a second dual serpentine giant magnetoresistive element magnetically biased along the primary axis and electrically connected with the first giant magnetoresistive element to form a Wheatstone bridge configuration.

6. The eddy current sensor of claim 5 wherein the magnetic field from the magnet also biases the giant magnetoresistive elements along their secondary axes.

7. The eddy current sensor of claim 1 wherein the magnetic field from the magnet also biases the giant magnetoresistive element along its secondary axis.

8. An eddy current sensor comprising:
a structural element;
a magnet held by the structural element; and
a first giant magnetoresistive element held by the structural element such that the magnetic field from the magnet biases the magnetoresistive element along the primary axis.

9. The eddy current sensor of claim 8 further comprising three additional giant magnetoresistive elements magnetically biased along the primary axis and electrically connected with the first giant magnetoresistive element to form a Wheatstone bridge configuration.

10. The eddy current sensor of claim 9 wherein the magnetic field from the magnet also biases the giant magnetoresistive elements along their secondary axes.

11. The eddy current sensor of claim 10 further comprising sensing circuitry that reads the bridge voltage of the wheatstone bridge and produces an output that indicates the presence or absence of nearby eddy currents.

12. The eddy current sensor of claim 8 wherein the first giant magnetoresistive element is a dual serpentine giant magnetoresistive element and further comprising a second dual serpentine giant magnetoresistive element magnetically biased along the primary axis and electrically connected with the first giant magnetoresistive element to form a Wheatstone bridge configuration.

13. The eddy current sensor of claim 12 wherein the magnetic field from the magnet also biases the giant magnetoresistive elements along their secondary axes.

14. The eddy current sensor of claim 8 wherein the magnetic field from the magnet also biases the giant magnetoresistive element along its secondary axis.

15. A method of sensing eddy currents comprising:
placing a magnet near a place that eddy currents occur; and
placing a first giant magnetoresistive element near the place that eddy currents occur and in a position that causes magnetic field created by the magnet to bias the giant magnetoresistive element along the primary axis.

16. The method of claim 15 further comprising using a total of four giant magnetoresistive elements magnetically biased along the primary axis and electrically connected in a wheatstone bridge configuration.

17. The method of claim 16 further comprising using the magnetic field from the magnet to also bias all four giant magnetoresistive elements along their secondary axes.

18. The method of claim 17 further comprising using a sensing circuit to read the bridge voltage of the wheatstone bridge and produce an output that indicates the presence or absence eddy currents near the giant magnetoresistive elements.

19. The method of claim 15 wherein the first giant magnetoresistive element is a dual serpentine giant magnetoresistive element and further comprising using a second dual serpentine giant magnetoresistive element magnetically biased along the primary axis and electrically connected with the first giant magnetoresistive element to form a Wheatstone bridge configuration.

20. The method of claim 19 further comprising using the magnetic field from the magnet to also bias the giant magnetoresistive elements along their secondary axes.

21. The method of claim 20 further comprising using the magnetic field from the magnet to also bias the giant magnetoresistive element along its secondary axes.
